(19) United States
(12) Patent Application Publication
(10) Pub. No.: US 2009/0146780 A1
(43) Pub. Date: Jun. 11, 2009

(54) UNIQUE IDENTIFICATION SYSTEM

(76) Inventors: Donald R. Hancock, Frisco, TX (US); Ronald R. Bandy, Plano, TX (US); Phillip W. Williams, Plano, TX (US); Lane J. Segerstrom, Mckinney, TX (US)

Correspondence Address: DeLeon Law Group PC, 100 Crescent Court, Suite 700, Dallas, TX, 75201, US

(21) Appl. No.: 12/246,313

(22) Filed: Oct. 6, 2008

Related U.S. Application Data
(60) Provisional application No. 60/978,028, filed on Oct. 5, 2007.
(60) Provisional application No. 60/977,997, filed on Oct. 5, 2007.

(51) Int. Cl. G06F 7/04

(52) U.S. Cl. 340/5.81

(57) ABSTRACT

An embodiment of the present invention includes a system and method for providing a unique and dynamic identification for members in a community.

### CROSS REFERENCE

Applicants claim priority based on provisional patent applications Ser. Nos. 60/978,028; and 60/977,997, both filed Oct. 5, 2007, and the non-provisional patent application filed concurrently based on the 60/977,997, entitled: “Synchronized Interactive Demographic Analysis,” the entire contents of which are incorporated herein by reference.

### BRIEF DESCRIPTION OF THE DRAWINGS

For a more complete understanding of the present disclosure and its advantages, reference is now made to the following description taken in conjunction with the accompanying drawing, in which like reference numerals represent like parts:

FIG. 1 is a flow diagram of an embodiment of the present invention.

### DETAILED DESCRIPTION OF THE INVENTION

The following discussion is presented to enable a person skilled in the art to make and use the invention. The general principles described herein may be applied to embodiments and applications other than those detailed below without departing from the spirit and scope of the present invention as defined herein. The present invention is not intended to be limited to the embodiments shown but is to be accorded the widest scope consistent with the principles and features disclosed herein.

The present invention relates generally to a system and method for providing a unique identification for members in a community.

Currently, many Internet service providers have a registration process that requires users to become members. In addition, some Internet service providers may have contact information on persons that are not members. Although most of the members can be identified easily, there is not an efficient and secure method to identify members and non-members. Moreover, most identification methods are static and can not change when needed.

Therefore, a need exists for a system and method for providing a unique and dynamic identification for members in a community.

An embodiment of the present invention includes a system and method for providing a unique and dynamic identification for members in a community.

An embodiment of the present invention works within a community of an Internet service provider. The community consists of Members that register for a set of services and requires an identification symbol (ID) for each Member. In this embodiment, the ID is referred to as the 6ID. The 6ID created for each Member is be a unique set of alphanumeric symbols which identifies the member. The 6ID also includes a unique serial number, demographic and “interest” markers. The “unique serial number” is “static,” and remains the same throughout the individual's connection with community. The rest of the 6ID is dynamic, and changes as the individual moves from Resource (a non-member that is listed on another Member's list) to Member to a higher level Member.

Each Resource and Member is identified within three categories: 1) Non-Valid (Resource of some Member, not a Member themselves; 2) Valid (or validated Member); and 3) Validated Level 1-4.

This may also be used to facilitate a method of consolidate Member updates across the database as a Member's status changes from Resource to Member. Since the main database resides across the Inventor's servers, as an individual moves from Resource to Member to Validated Member, any other connected Member will automatically be updated to the change in status as soon as they log on. The change is status will be obvious from their STOR label.

As a new user chooses to enter the community website, they are prompted to “sign-up” as a new Member, and then are asked to validate his/her information. Upon validation by that user, the community engine will create and assign a new and unique identification number to that particular user, or expand the number assigned as a Resource only. This identification number, or 6ID, will remain attached to this user indefinitely, or at the point of community's deconstruction. The 6ID in one sense can be viewed as a type of Online Social Security Number. The 6ID consists of multiple identification fields such as but not limited to: City, State, Region, Age, Gender, Field of Expertise, level of engagement authorized, and “Valid” or Non-Valid” Member.

Becoming a “Valid” Member is a process members must go through in order to finalize credibility standing amongst the community. Validation can occur with entry of valid credit card information, or other payment information. For example, any member joining is assigned a 6ID. While this will allow them to interact as a Member, this will not allow them to interact with status as a Validated Member. They can do a search, but cannot become validated until they perform a Cash Trax transaction, thereby validating their identity. Once a user enters a credit card number, as example for one validation criteria, the 6ID will automatically change the last digit to “Valid” and then reflect user as “Validated.”

As in the case where a validated STO member would add Resources to his/her Resource Manager, the same engine will also assign a “6ID” to each Resource. Again, specific digits within the ID number reflect a “Non-Validated” “Resource” not a Member. If and when that Member's Resource decides to register as a full fledged member, his/her existing “partial” 6ID would be added to in order to reflect new standing. In an instance where multiple Members maintain the same individual as a contact Resource, the 6IDs would be merged at the time of validation. Only the Member listing the Resource first receives rating credit for the new Member.

For a Member to enter into a “Valid+1-4” standing several additional actions must be taken by that Member. This includes the use of biometric identification devices. As various biometric peripherals become available to the home user these biometric tests (i.e. retinal scanner, thumbprint ID, etc.) could be used to produce additional lines of credibility. For example, Bill Gates may only want to “open” or “Turn-On” his profile to Members holding a specific Rating (+) Valid+3. This would ensure beyond a shadow of doubt the users identity and credibility.

Each 6ID is indexed within the community database according to similar metrics. Therefore similar 6IDs can be indexed together, and in similar fashion, to ensure a quick retrieval upon any search request execution from Members.

Another embodiment of the invention is in coordination with the synchronized interactive demographic analysis (sida). In this embodiment, the 6id is used as the unique identifier for data transmitted over the internet for accumulation of demographic data relative to opinion polls and product release approvals. Since the 6id already establishes within itself certain demographic data, the processing time and efficiency of the application is enhanced and data transmission is reduced.

In this embodiment, the 6ID will have been assigned and the member validated. An event such as a Virtual Political Rally or a Market Focus Group will be sponsored and the member registered to the SIDA system using their 6ID. Ad the event progresses, those registered will indicate their pleasure or displeasure at the concept or candidate being presented. This approval or disapproval will be instantaneously accumulated across all those registered, via the Internet. Because the 6ID inherently carries demographic data, these demographics will be efficiently transmitted with the approval/disapproval information. This provides a unique capability for gathering and organizing demographic analysis across the Internet which is lacking at present.

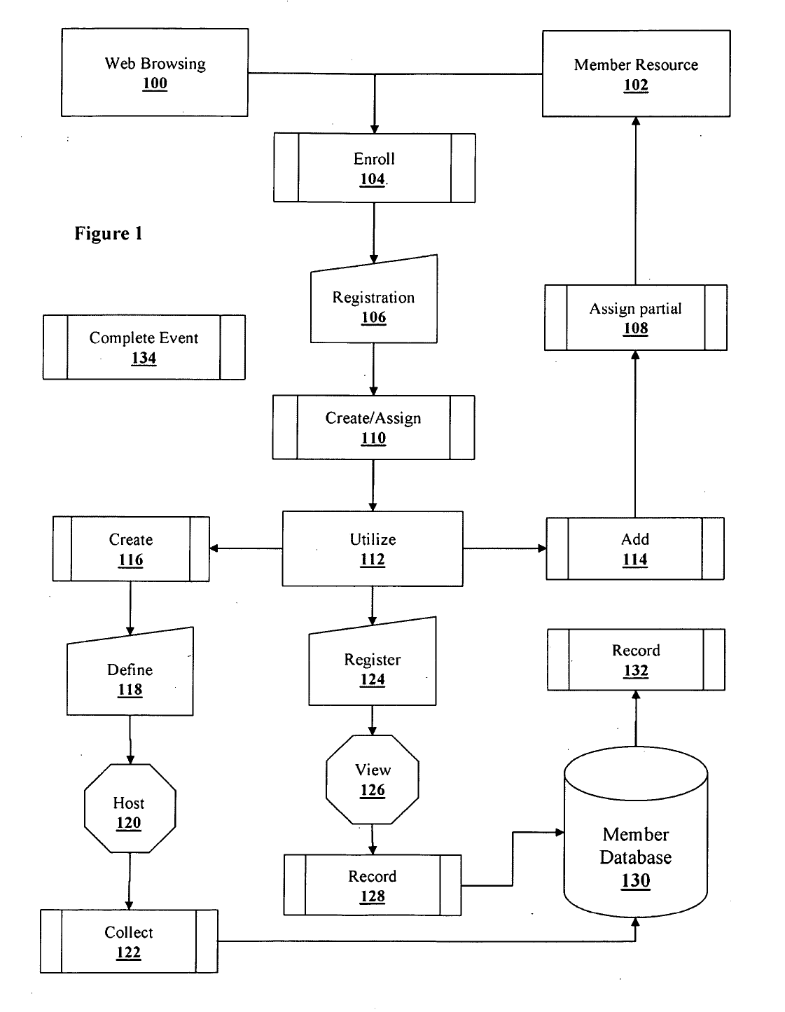

An example event is shown in FIG. 1. In this example, a user is either a brand new user 100, or is a member resource 102. Either way, the user enrolls 104 by registering 106 and enters their information. A 6ID is then created and assigned to the new member and is recorded in a member database 130. The member can then utilize the membership 112. One option is to create an event 116. The member first defines 118 required interest factors and then can host 120 an event. Demographics are then collected 122 and recorded in the member database 130.

The member can also register 124 for an event. Once the member registers for the event, they can view 126 the event. The system then allows the member to record 128 interest factors for the event which is then recorded in the member database 130. However, other occasions exist when the membership database will record 132 interest factors for an event.

The member can also add 114 human resources that get assigned 108 a non-validated 6ID. In addition, the new human resource can also decide 102 to join and will then begin the signup process 104.

The reuse of the 6ID in different applications and events simplifies the registration process for each event which may encompass millions of users; and it also provides unique demographic information on each individual registrant which may be used in behavioral advertising via Ad-Flame.

The 6ID is unique because the ID itself is created to include demographic data. When a community search takes place among millions of Members, the age, sex, location, and interest information are embedded in the 6ID itself, significantly reducing the time and effort involved in searching for the target Resource throughout the database.

Another unique feature of the 6ID is the concept that the ID will change dynamically without human intervention as more is learned about the Resource/Member. The System itself updates key fields of the 6ID as the demographic and interest information becomes available. One example of the fields of 6ID is illustrated in the table below.

Basic Number

| Serial | Zip | Sex | YOB | Int1 | Int2 | Int3 |
|---|---|---|---|---|---|---|
| AA-XXXXX- | XXXXX- | A- | XXXX- | XXX- | XXX- | XXX |

The Serial field—Two letters followed by five (5) digits serialized. The Serial field of the number is assigned upon entry to the community, either as a Resource of an existing Member, or as a Member. This provides for 100,000 people in a single zip code with unique numbers.

The Zip field—The five (5) digit zip code of the address of the Member.

The Sex field—A one-letter field, limited to M or F.

The YOB field—Year of birth, as noted in the registration process, or subsequently through Credit Card available information.

The Intx field—Interest fields which are table driven. As the Member lists more Interests, the reference list attached to this part of the number will grow. These will initially be 000. However, as the system “learns” more about the Member, this field will be changed to existing Interest numbers or newly created Interest numbers.

In different applications, these Interest Fields may change only for the duration of the event. For instance, in a Virtual Political Rally, the Registrants may be required to specify if they are Democrat, Republican, Independent, or non-aligned. The Interest Field would change for that Rally, and the registration information be kept associated with that person after the VPR ends. In a Market Focus Group, individuals might have to specify at registration for the Focus Group if they normally prefer American cars, Japanese cars, German cars, or other European cars. Again, once the Focus Group is ended, the information will still be kept in the Member's preferences file, in order to provide targeted marketing to the Member.

The previous description of the disclosed embodiments is provided to enable those skilled in the art to make or use the present invention. Various modifications to these embodiments will be readily apparent to those skilled in the art and generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method for providing a unique and dynamic identification for members in a community, the method comprising:
assigning a static portion of the identification;
assigning a dynamic portion of the identification based on a plurality of interests; and
assigning a portion of the identification based on gender
assigning a portion of the identification based on a portion of an address of the member;
assigning a portion of the identification based on year of birth of the member; and
assigning a dynamic portion of the identification based on rating.
